(19) United States
(12) Patent Application Publication
(10) Pub. No.: US 2024/0185446 A1
(43) Pub. Date: Jun. 6, 2024

(54) DETECTION SYSTEM, MOBILE TERMINAL, DETECTION DEVICE, AND COMPUTER READABLE MEDIUM

(71) Applicant: Mitsubishi Electric Corporation, Tokyo (JP)

(72) Inventor: Futa Watanabe, Tokyo (JP)

(73) Assignee: Mitsubishi Electric Corporation, Tokyo (JP)

(21) Appl. No.: 18/443,594

(22) Filed: Feb. 16, 2024

Related U.S. Application Data
(63) Continuation of application No. PCT/JP2021/037141, filed on Oct. 7, 2021.

(51) Int. Cl. G06T 7/70

(52) U.S. Cl. CPC G06T 7/70; G06T 2207/30196

(57) ABSTRACT

A mobile terminal (10-1) detects a terminal-side time (TC) being a duration time of a stationary state of the mobile terminal (10-1) with using a motion sensor. The mobile terminal (10-1) transmits the terminal-side time (TC) and identification information which identifies the mobile terminal (10-1) to a detection device (20-1). The detection device (20-1) detects a person position from an image by image analysis, detects a device-side time (TS) being a duration time of a stationary state of a person existing in the image by image analysis, and compares the device-side time (TS) with the terminal-side time (TC). The detection device (20-1) decides whether or not to associate the person position with the identification information in accordance with a comparison result of the terminal-side time (TC) and the device-side time (TS).

### CROSS REFERENCE TO RELATED APPLICATIONS

This application is a Bypass Continuation of PCT International Application No. PCT/JP2021/037141, filed on Oct. 7, 2021, all of which is hereby expressly incorporated by reference into the present application.

### TECHNICAL FIELD

The present disclosure relates to a detection system, a mobile terminal, a detection device, a transmission program, and a detection program.

### BACKGROUND ART

Related prior art includes a target detection system which identifies a person in an image (for example, Patent Literature 1). The target detection system of Patent Literature 1 includes a server, a detection means, and a photographing means. The detection means detects a tag held by the person. The server acquires identification information from the tag. Further, the server detects a position of the person from an image of the person photographed by the photographing means. The server integrates the acquired identification information and the detected position to identify who is where.

### CITATION LIST

### Patent Literature

Patent Literature 1: JP 2019-091437 A

### SUMMARY OF INVENTION

### Technical Problem

When identification information of a plurality of people exist, the technique disclosed in Patent Literature 1 cannot decide which identification information should be associated with person position information detected by an image analysis unit. Hence, the technique of Patent Literature 1 cannot correctly associate the person position information and the identification information with each other.

The present disclosure has as its objective to provide a device that can correctly associate person position information and identification information with each other when a plurality of people exist.

### Solution to Problem

A detection system according to the present disclosure includes a mobile terminal carried by a person and a detection device which detects a position of the person,
wherein the mobile terminal has
a terminal-side stationary state detection unit to detect a terminal-side time expressing a duration time of a stationary state of the mobile terminal with using a motion sensor, and
a transmission control unit to transmit the terminal-side time and identification information which identifies the mobile terminal, and
wherein the detection device comprises
a reception control unit to receive the terminal-side time and the identification information,
a position detection unit to detect a person position from an image by image analysis of the image photographed by a photographing device,
a device-side stationary state detection unit to detect a device-side time indicating a duration time of a stationary state of the person existing in the image by image analysis, and to compare the device-side time with the terminal-side time, and
an associating unit to decide whether or not to associate the person position with the received identification information in accordance with a comparison result of the terminal-side time and the device-side time.

### Advantageous Effects of Invention

A detection system according to the present disclosure includes a mobile terminal to detect a terminal-side time and a detection device to detect a device-side time. The detection device decides whether or not to associate a person position with identification information in accordance with a terminal-side time and a device-side time. Therefore, when a plurality of people exist, the detection system can correctly associate the person position and the identification information with each other.

### BRIEF DESCRIPTION OF DRAWINGS

FIG. 1, being a diagram of Embodiment 1, illustrates a configuration of a detection system 30.

FIG. 2, being a diagram of Embodiment 1, illustrates a hardware configuration of a mobile terminal 10.

FIG. 3, being a diagram of Embodiment 1, illustrates a hardware configuration of a detection device 20.

FIG. 4, being a flowchart of Embodiment 1, explains operations of the mobile terminal 10 and detection device 20 of the detection system 30.

FIG. 5, being a diagram of Embodiment 1, explains how a detection device 20-1 associates a terminal ID and a person position with each other.

FIG. 6, being a diagram of Embodiment 1, explains a terminal-side time TC and a device-side time TS.

FIG. 7, being a diagram of Embodiment 1, illustrates how the terminal ID and a person position are associated with each other.

FIG. 8, being a diagram of Embodiment 1, illustrates a hardware configuration of a mobile terminal 10 in a detection system 30 according to Modification 1.

FIG. 9, being a diagram of Embodiment 1, explains necessity of Modification 1.

FIG. 10, being a flowchart of Embodiment 1, illustrates operations of the detection system 30 of Modification 1.

FIG. 11, being a diagram of Embodiment 1, illustrates a comparative example of Modification 1, and Modification 1.

FIG. 12, being a diagram of Embodiment 1, is a hardware configuration diagram of a mobile terminal 10 in Modification 2.

FIG. 13, being a diagram of Embodiment 1, is a hardware configuration diagram of a detection device 20 in Modification 2.

FIG. 14, being a diagram of Embodiment 1, illustrates a case where a transmission destination device 20D is determined erroneously.

FIG. 15, being a diagram of Embodiment 1, illustrates a detection system 30 of Modification 3.

FIG. 16, being a diagram of Embodiment 1, illustrates a configuration in which functions of the detection device 20 are implemented by hardware.

### DESCRIPTION OF EMBODIMENTS

In description and drawings of embodiments, the same elements and equivalent elements are denoted by the same reference numeral. Description of an element denoted by the same reference numeral will be appropriately omitted or simplified. In the following embodiments, a term “unit” may be appropriately replaced by “circuit”, “stage”, “procedure”, “process”, or “circuitry”.

### Embodiment 1

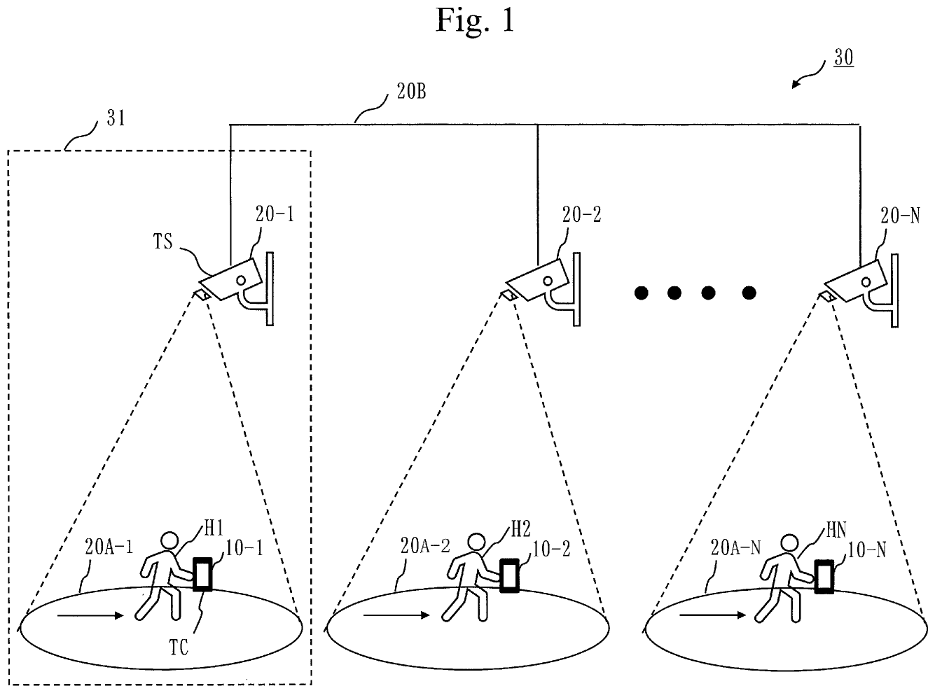

A detection system 30 of Embodiment 1 will be described with referring to FIGS. 1 to 16. The detection system 30 detects a position of a person. The detection system 30 is provided with a mobile terminal 10 carried by the person and a detection device 20 which detects the position of the person.

### *** Description of Configurations ***

FIG. 1 illustrates a configuration of the detection system 30. The detection system 30 is provided with detection devices 20-1, 20-2, . . . , 20-N, and mobile terminals 10-1, 10-2, . . . , 10-N. The mobile terminals 10-1, 10-2, . . . , 10-N are carried by persons H1, H2, . . . , NH. The detection devices 20-1, 20-2, . . . , 20-N are connected to a network 20B. The network 20B may be a wired network or a wireless network. Configurations of the detection devices 20-1, 20-2, . . . , 20-N are the same. Configurations of the mobile terminals 10-1, 10-2, . . . , 10-N are the same.

The detection system 30 may be provided with a basic unit 31 at least. The basic unit 31 is provided with one mobile terminal 10 and one detection device 20. If the mobile terminals need not be discriminated from each other, they are expressed as mobile terminals 10. If the detection devices need not be discriminated from each other, they are expressed as detection devices 20.

A description will be made for the basic unit 31 as an example. As will be described later, the detection device 20-1 is provided with a photographing device 241. In the basic unit 31, a state is illustrated in which the person H1 has entered a detection area 20A-1 where the photographing device 241 can detect a person. The person H1 carries the mobile terminal 10-1. The mobile terminal 10-1 stores identification information that identifies the mobile terminal 10-1. The identification information will be expressed as terminal ID hereinafter. The mobile terminal 10-1 is capable of communicating with the detection device 20-1. The mobile terminal 10-1 is provided with a motion sensor. The mobile terminal 10-1 detects a terminal-side time TC of the person H1 with the motion sensor and transmits the terminal-side time TC and the terminal ID to the detection device 20-1. Note that there is a case where the mobile terminal 10-1 transmits the terminal-side time TC and the terminal ID to a detection device 20 other than the detection device 20-1. This will be described later.

The description for the basic unit 31 also applies to the other mobile terminals 10 and the other detection devices 20.

### <Hardware Configuration of Mobile Terminal 10>

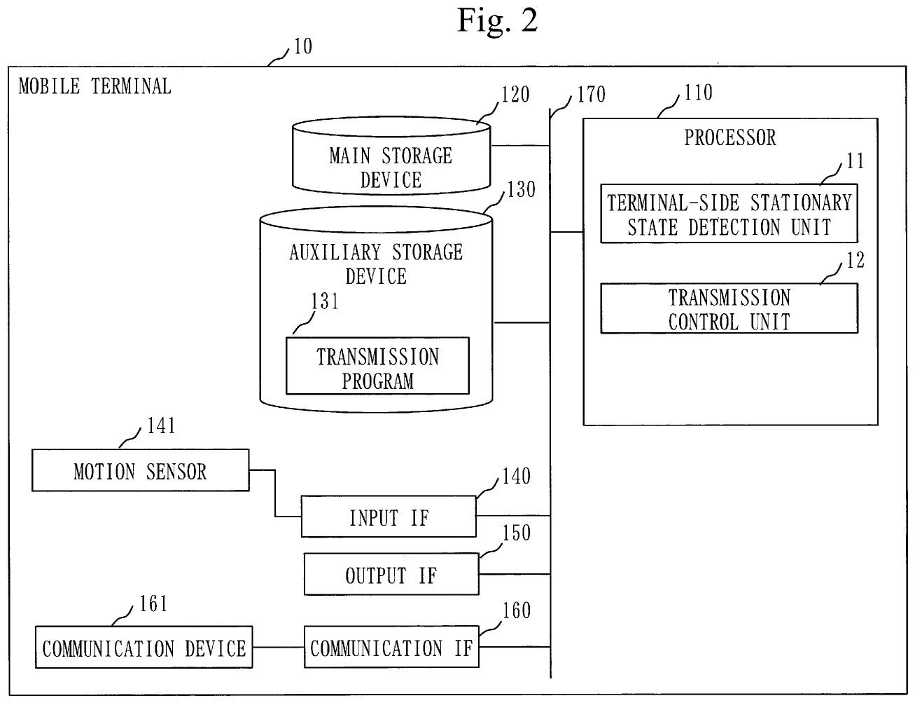

FIG. 2 illustrates a hardware configuration of the mobile terminal 10. The mobile terminal 10 is a computer. The mobile terminal 10 is provided with a processor 110. The mobile terminal 10 is provided with a plurality of hardware devices in addition to the processor 110. The plurality of hardware devices are a main storage device 120, an auxiliary storage device 130, an input IF 140, an output IF 150, and a communication IF 160. Note that IF stands for interface. The processor 110 is connected to the other hardware devices via a signal line 170 and controls the other hardware devices.

The mobile terminal 10 is provided with a terminal-side stationary state detection unit 11 and a transmission control unit 12 as function elements. Functions of the terminal-side stationary state detection unit 11 and transmission control unit 12 are implemented by a transmission program 131. The terminal-side stationary state detection unit 11 detects the terminal-side time TC expressing a duration time of a stationary state of the mobile terminal 10 with using a motion sensor 141. The transmission control unit 12 transmits the terminal-side time TC and the identification information ID which identifies the mobile terminal.

The processor 110 is a device that runs the transmission program 131. The processor 110 runs the transmission program 131 to implement the functions of the terminal-side stationary state detection unit 11 and transmission control unit 12. The processor 110 is an Integrated Circuit (IC) which performs computation processing. Specific examples of the processor 110 are a Central Processing Unit (CPU), a Digital Signal Processor (DSP), and a Graphics Processing Unit (GPU).

The main storage device 120 is a storage device. Specific examples of the main storage device 120 are a Static Random-Access Memory (SRAM) and a Dynamic Random-Access Memory (DRAM). The main storage device 120 holds a computation result of the processor 110.

The auxiliary storage device 130 is a storage device that keeps data in a nonvolatile manner. A specific example of the auxiliary storage device 130 is a Hard Disk Drive (HDD). The auxiliary storage device 130 may be a portable recording medium. Examples of the portable recording medium include a Secure Digital (SD: registered trademark) memory card, a NAND flash, a flexible disk, an optical disk, a compact disk, a Blu-ray (registered trademark) disk, and a Digital Versatile Disk (DVD). The auxiliary storage device 130 stores the transmission program 131.

The input IF 140 is a port to which data is inputted from the individual devices. The motion sensor 141 is connected to the input IF 140. Various types of apparatuses are connected to the output IF 150. The output IF 150 is a port via which data is outputted to the various types of apparatuses by the processor 110. The communication IF 160 is a communication port via which the processor communicates with the other devices. A communication device 161 is connected to the communication IF 160.

The processor 110 loads the transmission program 131 from the auxiliary storage device 130 to the main storage device 120. The processor 110 reads the loaded transmission program 131 from the main storage device 120 and runs the transmission program 131. In addition to the transmission program 131, an Operating System (OS) is also stored in the main storage device 120. The processor 110 runs the transmission program 131 while running the OS. The mobile terminal 10 may be provided with a plurality of processors that substitute for the processor 110. The plurality of processors run the transmission program 131 by sharing. Each processor is a device that runs the transmission program 131 just as the processor 110 does. Data, information, a signal value, and a variable value which are utilized, processed, or outputted by the transmission program 131 are stored in the main storage device 120, the auxiliary storage device 130, or a register or cache memory in the processor 110.

The transmission program 131 is a program that causes the computer to execute processes, procedures, or stages corresponding to the terminal-side stationary state detection unit 11 and the transmission control unit 12, each with its “unit” being replaced by “process”, “procedure”, or “stage”.

A transmission method is a method that is practiced by the mobile terminal 10 being the computer as the mobile terminal 10 runs the transmission program 131. The transmission program 131 may be provided as being stored in a computer readable recording medium, or may be provided as a program product.

### <Hardware Configuration of Detection Device 20>

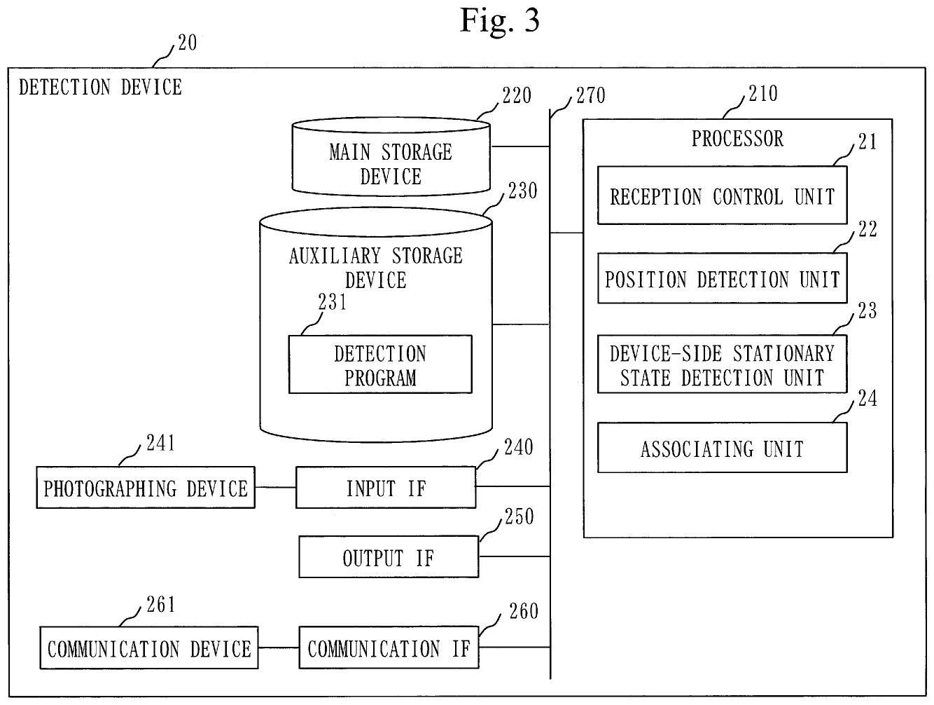

FIG. 3 illustrates a hardware configuration of the detection device 20. The detection device 20 is a computer just as the mobile terminal 10 is. The detection device 20 will be described regarding its differences from the mobile terminal 10.

The detection device 20 is provided with a reception control unit 21, a position detection unit 22, a device-side stationary state detection unit 23, and an associating unit 24, as function elements. Functions of the reception control unit 21, position detection unit 22, device-side stationary state detection unit 23, and associating unit 24 are implemented by a detection program 231. A processor 210 runs the detection program 231 to implement the functions of the reception control unit 21, the position detection unit 22, the device-side stationary state detection unit 23, and the associating unit 24. An auxiliary storage device 230 stores the detection program 231. The reception control unit 21 receives the terminal-side time TC and the identification information. An example of the identification information is a terminal ID. The position detection unit 22 detects a person position from an image through image analysis of the image photographed by the photographing device 241. The device-side stationary state detection unit 23 detects a device-side time TS indicating a duration time of a stationary state of a person existing in the image by image analysis, and compares the device-side time TS with the terminal-side time TC.

The associating unit 24 decides whether or not to associate the person position with the received identification information in accordance with a comparison result of the terminal-side time TC and the device-side time TS.

The photographing device 241 is connected to an input IF 240. A communication device 261 is connected to a communication IF 260.

The detection program 231 is a program that causes the computer to execute processes, procedures, or stages corresponding to the reception control unit 21, the position detection unit 22, the device-side stationary state detection unit 23, and the associating unit 24, each with its “unit” being replaced by “process”, “procedure”, or “stage”.

A detection method is a method practiced by the detection device 20 being the computer as the detection device 20 runs the detection program 231. The detection program 231 may be provided as being stored in a computer readable recording medium, or may be provided as a program product.

### *** Description of Operations ***

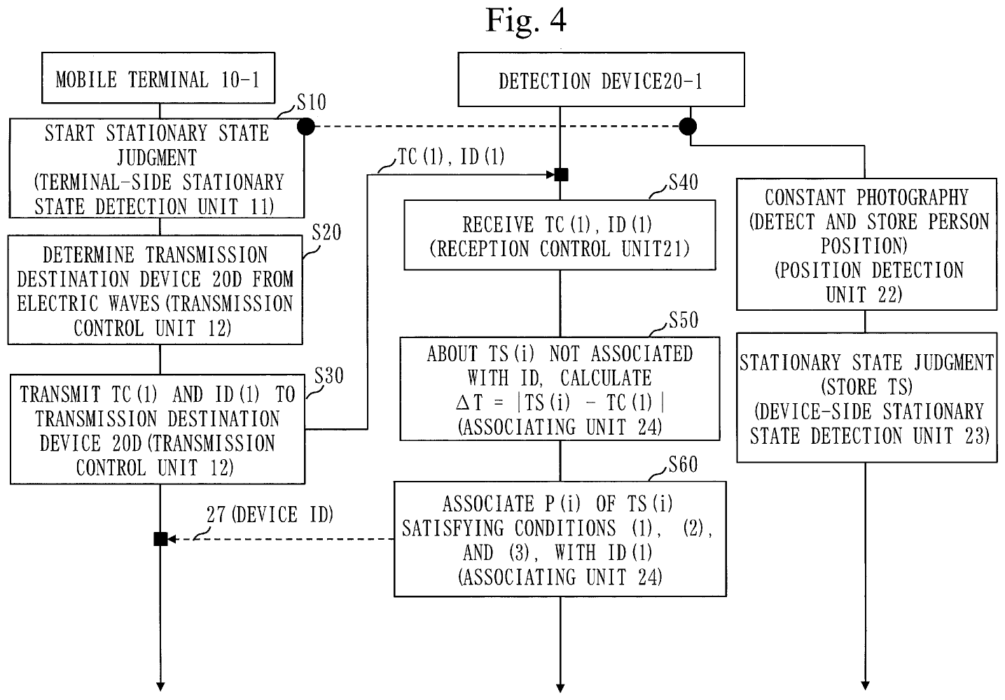

FIG. 4 is a flowchart to explain operations of the mobile terminal 10 and detection device 20 of the detection system 30.

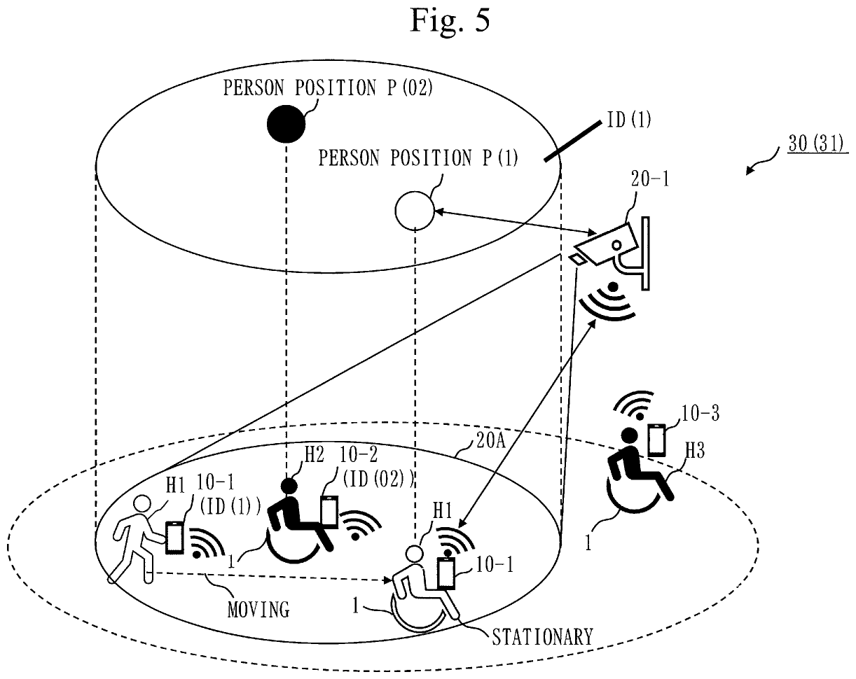

FIG. 5 illustrates a case where the person H1 having the mobile terminal 10-1 enters a detection area 20A, and after the entry, is seated on a chair 1 and becomes stationary. An upper part of FIG. 5 is a plan view of the detection area 20A seen from the above. The operations of the detection system 30 will be described with referring to FIGS. 4 and 5. The operations of the mobile terminal 10 correspond to the transmission method. The operations of the mobile terminal 10 also correspond to processing of the transmission program 131. The operations of the detection device 20 correspond to the detection method. The operations of the detection device 20 also correspond to processing of the detection program 231.

### <Step S10>

In step S10, in the mobile terminal 10-1 held by the person H1, the terminal-side stationary state detection unit 11 starts stationary state judgment for the mobile terminal 10-1 with the motion sensor 141. The terminal-side stationary state detection unit 11 starts measuring a stationary state duration time by a timer function simultaneously with start of the stationary state judgment.

### <Step S20>

The transmission control unit 12 determines a transmission destination device 20D to which the identification information and the terminal-side time should be transmitted, from among the plurality of detection devices 20, on a basis of characteristics of electric waves transmitted by the plurality of detection devices 20. The transmission control unit 12 transmits the identification information and the terminal-side time TC to the determined transmission destination device 20D. Each detection device 20 of the plurality of detection devices 20 detects a person position by image analysis and associates the person position with the identification information which identifies a mobile terminal.

This will be described below specifically.

In step S20, after stationary state judgment is started, the transmission control unit 12 receives electric waves of the plurality of detection devices 20. FIG. 5 illustrates only the detection device 20-1. In practice, however, the mobile terminal 10-1 receives electric waves from the plurality of detection devices 20. The transmission control unit 12 determines the transmission destination device 20D from among the plurality of detection devices 20 on a basis of electric wave information indicated by the electric waves received from the plurality of detection devices 20. The electric wave information is information such as an electric wave intensity, a flight time, and an arrival time difference. The electric wave information expresses electric wave characteristics.

### <Step S30>

In step S30, the transmission control unit 12 transmits the terminal ID and a timer count to the transmission destination device 20D. The terminal ID is an ID with which the mobile terminal 10-1 can be identified uniquely.

In the example of FIG. 4, the terminal ID of the mobile terminal 10-1 is expressed as ID(1). The timer count is a stationary state duration time of the mobile terminal 10-1 as measured by a timer. The timer count will be expressed as terminal-side time TC(1) hereinafter.

### <Person Position Detection in Constant Photography>

Each detection device 20 of the plurality of detection devices 20 constantly photographs the detection area 20A. In each detection device 20, the position detection unit 22 detects a person position in the detection area 20A and stores the detected person position. The person position is stored in the auxiliary storage device 230. Detection of the person position by the position detection unit 22 uses existing technology. The existing technology is a technology such as background subtraction, frame subtraction, and object detection.

### <Stationary State Judgment in Constant Photography>

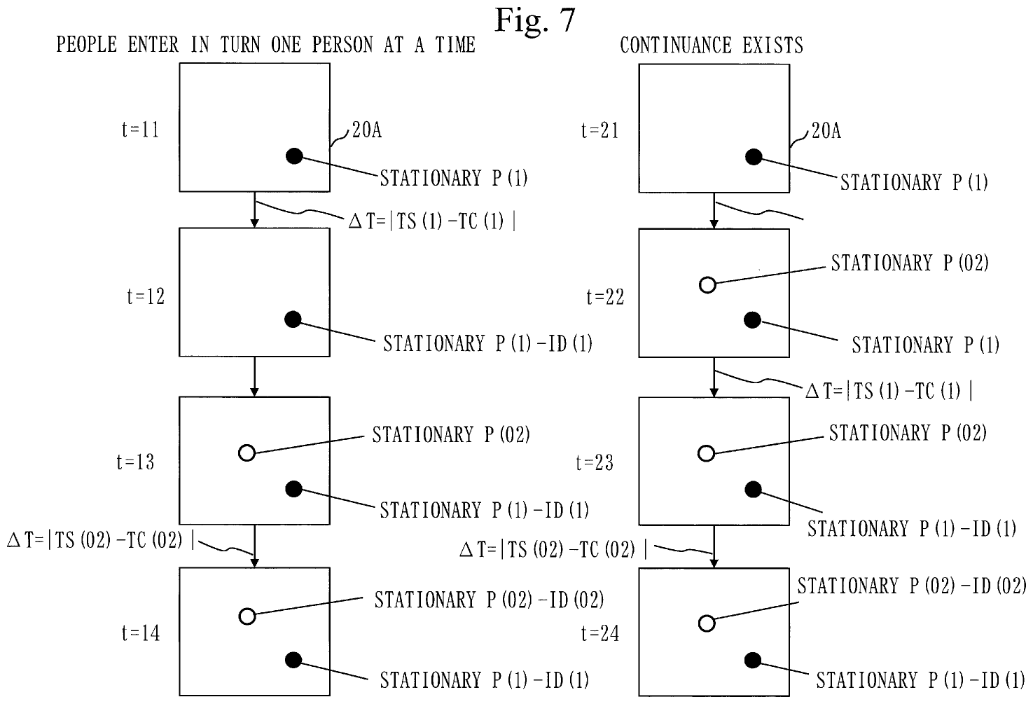

The device-side stationary state detection unit 23 judges a person H regarded to be stationary for a certain period of time, as in a stationary state, and detects a device-side time TS(i) of the stationary state. Details of the device-side time TS(i) will be described later with referring to FIG. 7. The device-side stationary state detection unit 23 acquires a person position of the stationary person H from the position detection unit 22 and associates the device-side time TS with a person position P(i). The device-side stationary state detection unit 23 associates the device-side time TS with the person position P(i) and stores the associated result in the auxiliary storage device 130.

### <Step S40>

In step S40, the reception control unit 21 receives the terminal-side time TC (1) and an ID(1).

### <Step S50>

In step S50, the associating unit 24 executes an associating process when TC (1) and ID(1) are received from the mobile terminal 10-1. The associating process is a process of attempting to associate a device-side time TS not associated with a terminal ID, with a received terminal ID. The associating unit 24 performs the process of associating the device-side time TS with the terminal ID on a basis of a magnitude relationship in value between the terminal-side time TC and the device-side time TS. The associating unit 24 calculates an absolute value ΔT of a difference between the device-side time TS and the terminal-side time TC. In the example of FIG. 4, the absolute value ΔT is given by the following Expression 1.

ΔT=|TS(i)−TC(1)| (Expression 1)

The associating unit 24 calculates Expression 1 for each device-side time TS(i) stored in the auxiliary storage device 230 where i=1, 2, . . . .

### <Step S60>

Assume that a threshold value is TH. In step S60, the associating unit 24 selects, from among the device-side time TS(i), a device-side time TS(i) that satisfies following (1), (2), and (3).
(1) ΔT is less than the threshold value TH.
(2) ΔT is minimum.
(3) The device-side time TS is not associated with a terminal ID.

Note that since the device-side time TS(i) is associated with the stationary-state person position P(i), (3) signifies “the person position P(i) is not associated with the terminal ID”.

When the associating unit 24 selects TS(1), this is the same as selecting a person position P(1) associated to TS(1). When the person position P(1) is selected, the associating unit 24 associates the person position P(1) with ID(1) and stores the associated result in the auxiliary storage device 230.

### <Transmission of Failure Notice 27>

If ΔT is equal to or larger than the threshold value TH, the associating unit 24 of the detection device 20-1 judges that the person who holds the mobile terminal 10-1 having ID(1) has not entered the detection area 20A. If ΔT of Expression 1 is equal to or larger than the threshold value TH, “(1) ΔT is less than the threshold value TH.” is not satisfied, so associating ID(1) fails. When the associating fails, the associating unit 24 transmits a failure notice 27 to the mobile terminal 10-1 having ID(1). The failure notice 27 contains the device ID of the detection device 20-1 being the transmission destination device 20D. Note that the associating unit 24 transmits the device ID of the detection device 20-1 to the mobile terminal 10-1 when also the associating is successful. This enables the mobile terminal 10-1 to be aware of the detection device 20-1 that has succeeded in associating.

As described above, when it is determined that the person position will not be associated with the received identification information, the associating unit 24 transmits a failure notice notifying failure of associating the person position with the identification information.

### (Reception of Failure Notice 27)

When the failure notice 27 is received, in the mobile terminal 10-1, the process of step S20 is performed. Since the device ID is received through the failure notice 27, the transmission control unit 12 determines a transmission destination device 20D different from the detection device 20-1. Subsequently, the mobile terminal 10-1 carries out the detection system 30. Step S20 and step S30 are repeated each time a failure notice 27 is received.

When none of the plurality of detection devices 20 was able to be associated with ID(1), the mobile terminal 10-1 ends the ID(1) associating process.

As described above, after transmitting the identification information and the terminal-side time, the transmission control unit 12 receives from the transmission destination device the failure notice notifying failure of associating a person position with identification information. Upon reception of the failure notice, the transmission control unit 12 determines another transmission destination device to which the identification information and the device-side time TS should be transmitted, from among the plurality of detection devices 20.

FIG. 5 illustrates, concerning the person H1, a state in which the person position P(1) is associated with ID(1). A person H2 is at a person position P(02). However, in this state, the person position P(02) is not associated with ID(02) of the mobile terminal 10-2. A person H3 is located outside the detection area 20A and thus is not an associating target.

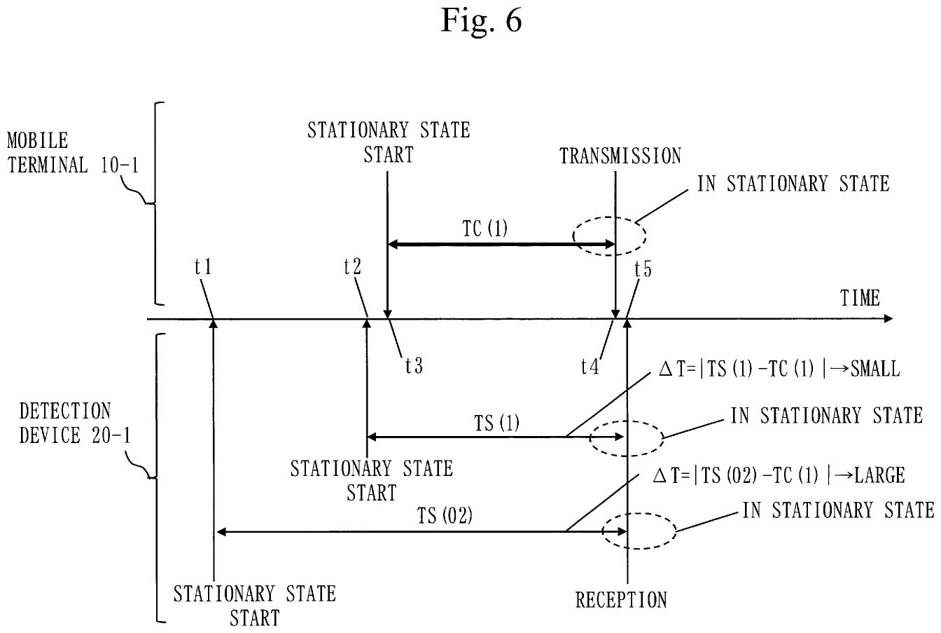

FIG. 6 is a diagram explaining the terminal-side time TC and the device-side time TS. FIG. 6 corresponds to FIG. 5.

The mobile terminal 10-1 will be featured. In the mobile terminal 10-1, the terminal-side stationary state detection unit 11 detects stationary state start of the mobile terminal 10-1 at time t3 with the motion sensor 141. At time t3, the timer starts measurement. At time t4, the terminal-side stationary state detection unit 11 finds with the timer and the motion sensor 141 that the stationary state duration time has reached the terminal-side time TC which is a regulation time. At time t4, the transmission control unit 12 transmits the terminal-side time TC(1) and ID(1) to the detection device 20-1. During the terminal-side time TC(1), the process of step S20 has been performed and the detection device 20-1 has been determined as the transmission destination device 20D. At time t4, the stationary state of the mobile terminal 10-1 having ID(1) continues.

The mobile terminal 10-2 of FIG. 6 will be featured. In the mobile terminal 10-2, the transmission control unit 12 has not transmitted ID(02) and a terminal-side time TC(02) to the detection device 20-1. In other words, the detection device 20-1 has not received ID(02) and the terminal-side time TC(02) from the mobile terminal 10-2.

The detection device 20-1 will be featured. The device-side stationary state detection unit 23 of the detection device 20-1 detects the device-side time TS(1). At time t2, the device-side stationary state detection unit 23 detects stationary state start at the person position P(1). From time t2 onwards, the device-side stationary state detection unit 23 continuously detects the stationary state of the person position P(1). At time t5, the reception control unit 21 receives ID(1) and the terminal-side time TC(1). The device-side stationary state detection unit 23 takes time t5 as an end of the device-side time TS(1). At this time point, in the device-side stationary state detection unit 23, the terminal-side time TC(1) and the device-side time TS(1) are not associated with each other. At time t1, the device-side stationary state detection unit 23 detects stationary state start at the person position P(02). From time t1 onwards, the device-side stationary state detection unit 23 continuously detects the stationary state of the person position P(02). Upon reception of the terminal-side time TC(1) at time t5, the device-side stationary state detection unit 23 takes time t5 as an end of the device-side time TS(02). By receiving the terminal-side time TC(1), the device-side time TS(i) associated with the person position P(i) during detection by the detection device 20-1 is fixed.

The associating unit 24 of the detection device 20-1 calculates

ΔT=|TS(1)−TC(1)|

and

ΔT=|TS(02)−TC(1)|

The associating unit 24 selects TS(i) that satisfies the conditions (1), (2), and (3) mentioned in step S60. Thus, the associating unit 24 selects the device-side time TS(1). Since the device-side time TS(1) is associated with the person position P(1), the device-side stationary state detection unit 23 associates the person position P(1) with ID(1).

As described in FIG. 6, the terminal-side time TC is a time length fixed as a regulation value. The device-side time TS is a time from stationary state start to reception of the terminal-side time TC. When the duration time of the stationary state of the mobile terminal 10 reaches the regulation value, the transmission control unit 12 of the mobile terminal 10 transmits the terminal ID, being identification information, and the terminal-side time TC.

Left part of FIG. 7 illustrates how to associate one person with whom a terminal ID has not been associated, with a terminal ID in turn. Right part of FIG. 7 illustrates how to associate a plurality of people with whom a terminal ID has not been associated, with a terminal ID in turn. FIG. 7 corresponds to FIG. 5. The left part of FIG. 7 will be described. The left part of FIG. 7 illustrates how time t passes in one detection area 20A.

At time t11, a stationary state of the person position P(1) is detected by the detection device 20-1.

At time t12, the person position P(1) is associated with ID(1) by the detection system 30.

At time t13, a stationary state of the person position P(02) is detected by the detection device 20-1.

At time t14, the person position P(02) is associated with ID(02) by the detection system 30.

The right part of FIG. 7 will be described. The right part of FIG. 7 also illustrates how time t passes in one detection area 20A.

At time t21, a stationary state of the person position P(1) is detected by the detection device 20-1.

At time t22, the stationary state of the person position P(02) is detected by the detection device 20-1.

At time t23, the person position P(1) is associated with ID(1) by the detection system 30. This is because the detection device 20-1 has received ID(1) and the terminal-side time TC(1) before time t23.

At time t24, the person position P(02) is associated with ID(02) by the detection system 30. This is because the detection device 20-1 has received ID(02) and the terminal-side time TC(02) before time t24.

### *** Effect of Embodiment 1 ***

According to the prior art, when a plurality of tags entered a detection area of one detection means, it was impossible to associate identification information obtained from each tag and position information obtained from an image with each other. In the detection system 30 of Embodiment 1, a terminal ID and a person position are associated with each other with using the terminal-side time TC and the device-side time TS. Hence, it is possible to associate individual ones of the plurality of person positions detected by the detection area 20A and the terminal IDs of the plurality of mobile terminals 10 with each other. According to the prior art, a plurality of detection means are necessary to associate one person position with one of a plurality of pieces of identification information. However, in the detection system 30 of Embodiment 1, a plurality of detection means are not necessary to associate one person position with a plurality of identification information. That is, in the detection system 30 of Embodiment 1, one personal position is associated with one of the plurality of terminal IDs with using the terminal-side time TC and the device-side time TS. Since this is done by software and not by hardware, one person position can be associated with one of the plurality of terminal IDs using a simple configuration.

### <Modification 1>

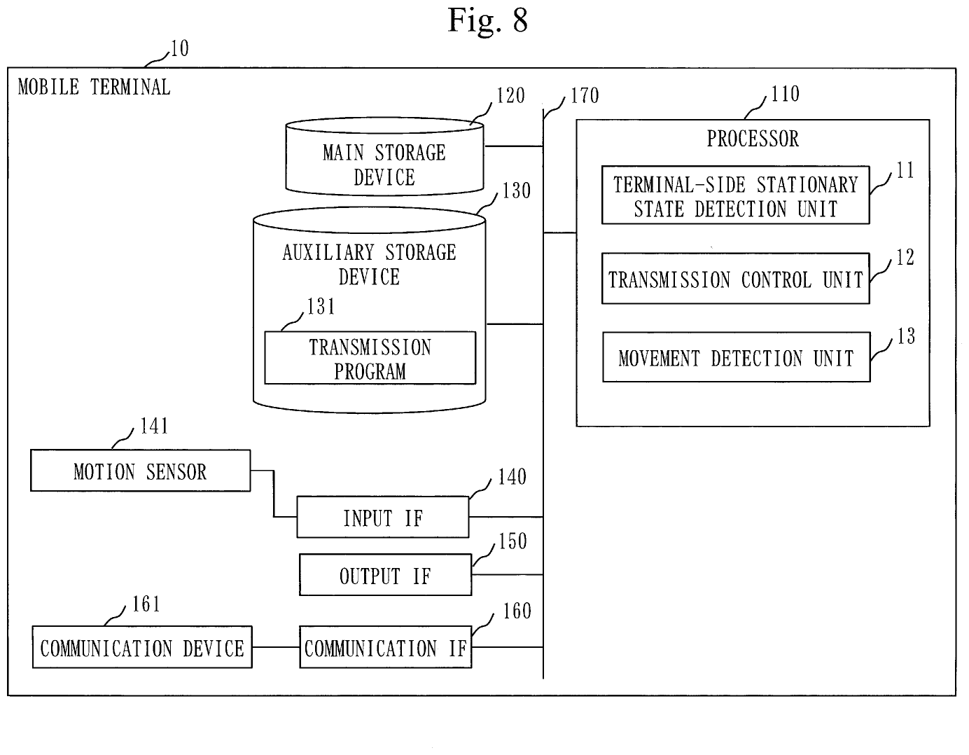

FIG. 8 illustrates a hardware configuration of a mobile terminal 10 in a detection system 30 according to Modification 1. The mobile terminal 10 of FIG. 8 is provided with a movement detection unit 13 when compared with the mobile terminal 10 of FIG. 2. In a detection system 30 of Modification 1, the system configuration is the same as that in FIG. 1, and hardware of a detection device 20 has the same configuration as that in FIG. 3.

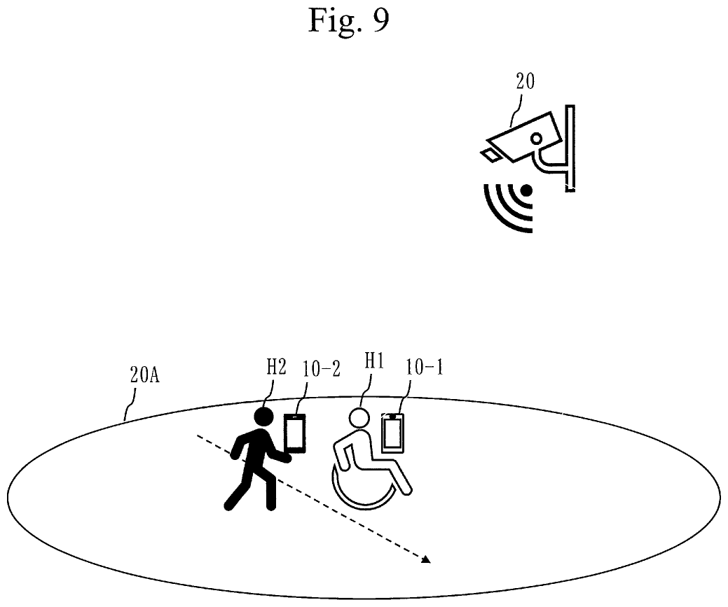

FIG. 9 is a diagram which explains necessity of Modification 1.

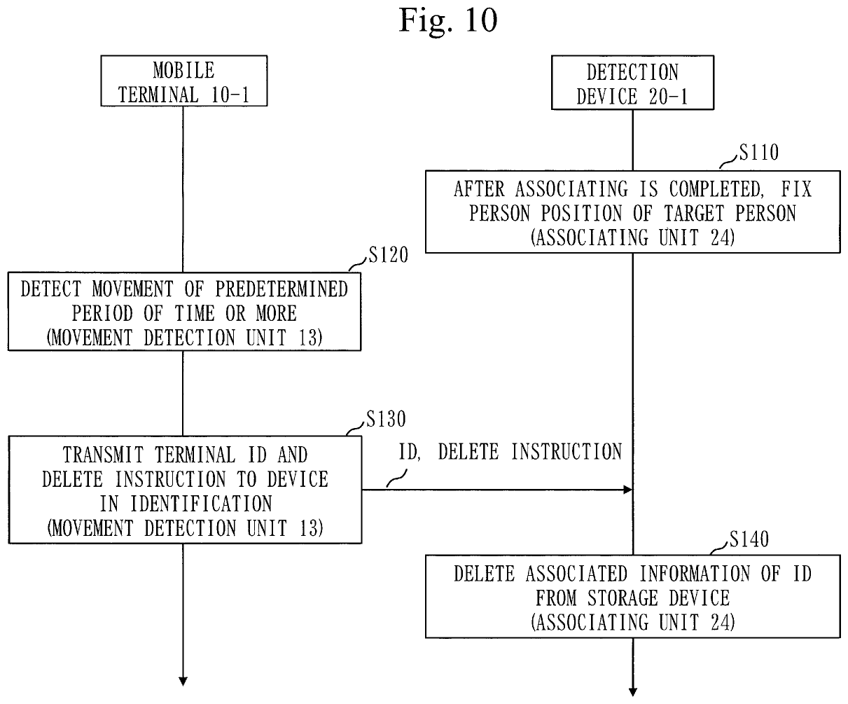

FIG. 10 is a flowchart illustrating operations of the detection system 30 of Modification 1.

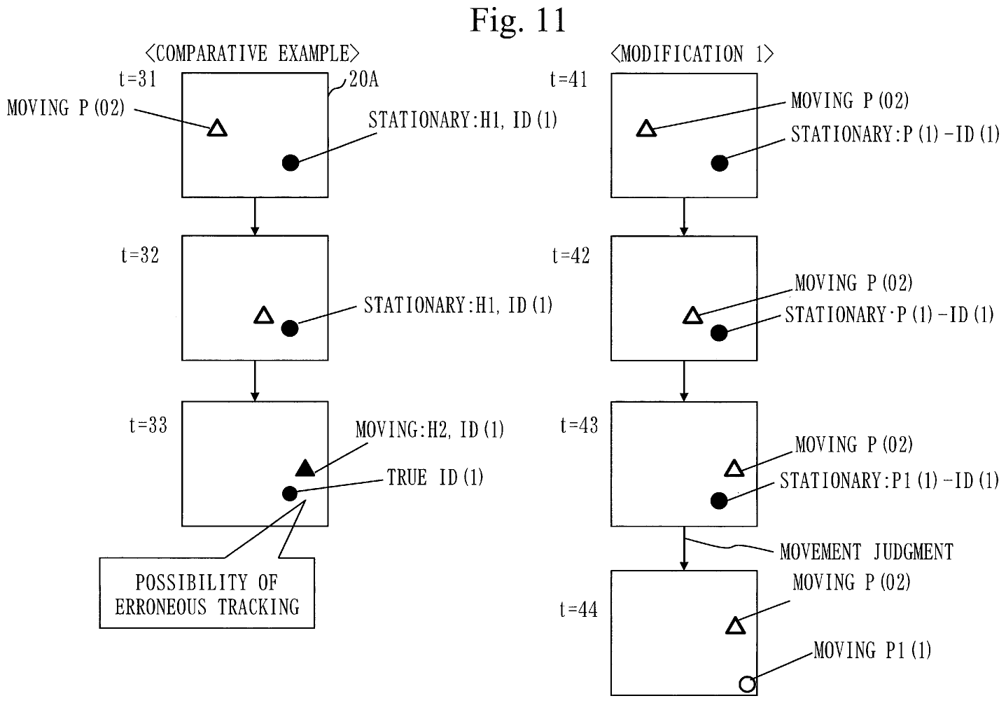

FIG. 11 illustrates Modification land a comparative example of Modification 1.

As illustrated in FIG. 9, there is a person H1 in a stationary state for whom a person position P(1) and a terminal ID(1) have been associated. Referring to left part of FIG. 11, in person position detection using a technology such as frame subtraction, when a different person H2 moves in a vicinity of the person H1 who is in the stationary state, the person position detection system is likely to erroneously judge that the person H1 in the stationary state is moving. The left part of FIG. 11 illustrates this erroneous detection. FIG. 11 can be viewed in the same manner as FIG. 7. Thus, in Modification 1, the terminal ID(1) is fixed to the person position P(1) of the person H1 in the stationary state, and the moving person H2 is not associated with the terminal ID(1). Hence, even if the different person H2 moves in the vicinity of the person H1 who is in the stationary state and for whom associating has been completed, there is no possibility that a person in the stationary state is erroneously judged to be moving. Therefore, Modification 1 is able to detect a person position with good precision. Modification 1 will be described below.

### <Step S110>

In the detection device 20 of Modification 1, when an associating unit 24 completed associating a person position P and a terminal ID with each other, the person position P of the target person H is fixed and will not be updated.

### <Step S120, Step S130>

In the mobile terminal 10, the movement detection unit 13 detects movement of the mobile terminal 10 of a predetermined period of time or more with using a motion sensor 141 (step S120). When movement of the predetermined period of time or more is detected, the movement detection unit 13 transmits to the detection device 20 that has done associating, the terminal ID of the mobile terminal 10-1, and a delete instruction which instructs deletion of associating information of the person position which the terminal ID has been associated with (step S130).

### <Step S140>

In the detection device 20, after the terminal ID and the delete instruction are received, the associating unit 24 deletes the associating-related information of the person position which the terminal ID has been associated with, from the storage unit.

Right part of FIG. 11 illustrates Modification 1.

At time t41, the person position P(1) is stationary, and a person position P(02) is moving.

The person position P(1) is associated with ID(1).

At time t42, the person position P(02) is moving. The person position P(1) is in the same state as that at time t41.

At time t43, the person position P(02) and the person position P(1) are moving.

At time t43, the person position P(1) is associated with ID(1).

From time t43 to time t44, the movement detection unit 13 performs movement judgment.

The movement detection unit 13 transmits ID and a delete instruction to a detection device 20-1.

At time t44, an associating unit 24 of the detection device 20-1 deletes information indicating associating. Hence, at time t44, how ID(1) is associated to the moving person position P(1) has been deleted by the associating unit 24.

As described above, the movement detection unit 13 transmits the identification information and the delete instruction which instructs deletion of information indicating associated relation of the identification information and the person position with each other, when a movement continuation state of a predetermined period of time of the mobile terminal is detected by the motion sensor. Upon reception of the delete instruction, the associating unit 24 deletes the information indicating associated relation of the identification information and the person position with each other.

### <Modification 2>

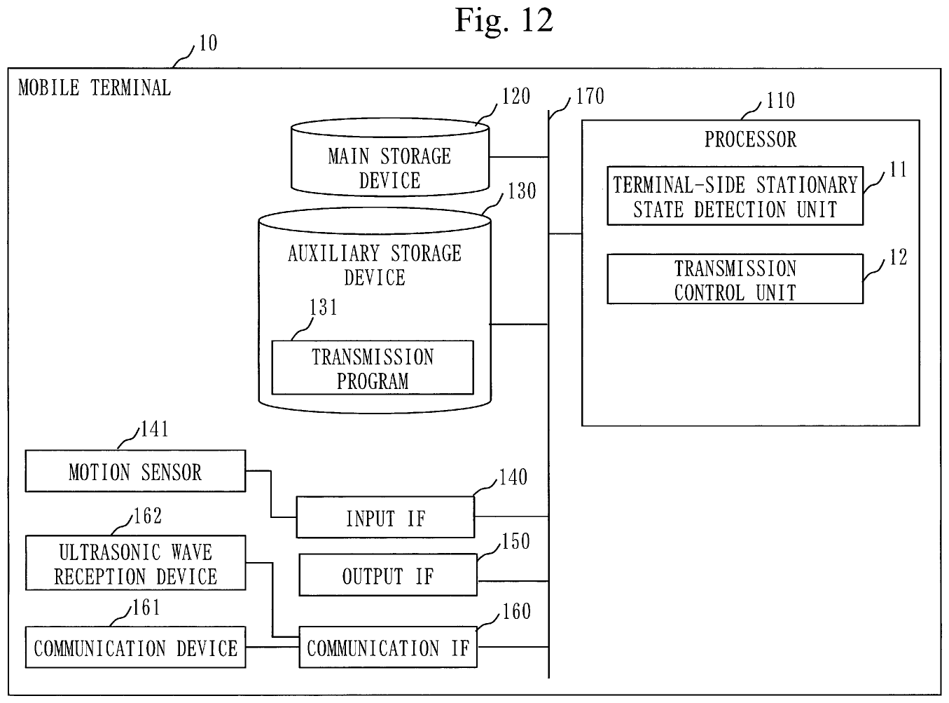

A detection system 30 according to Modification 2 will be described with referring to FIGS. 12 to 14. Modification 2 employs ultrasonic waves to determine a transmission destination device 20D. A system configuration of the detection system 30 in Modification 2 is the same as its equivalent in FIG. 2.

FIG. 12 illustrates a hardware configuration of a mobile terminal 10 in Modification 2.

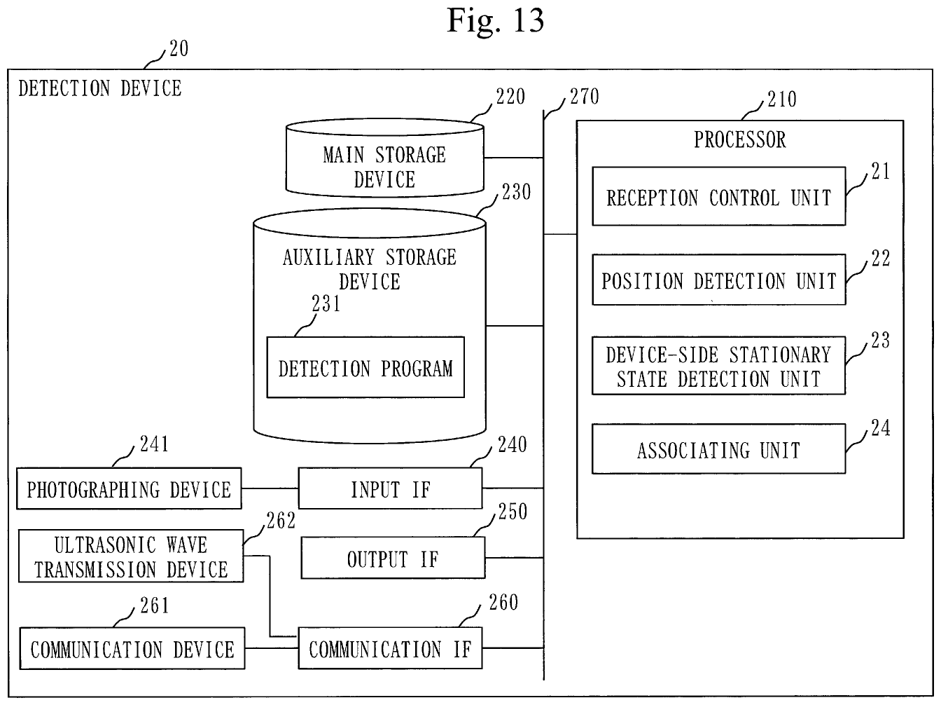

FIG. 13 illustrates a hardware configuration of a detection device 20 in Modification 2. The mobile terminal 10 has an ultrasonic wave reception device 162 when compared to FIG. 2. The detection device 20 has an ultrasonic wave transmission device 262 when compared to FIG. 3. A transmission control unit 12 determines the transmission destination device 20D through detection of the ultrasonic waves received via the ultrasonic wave reception device 162. The transmission control unit 12 transmits a terminal-side time TC and a terminal ID to the determined transmission destination device 20D.

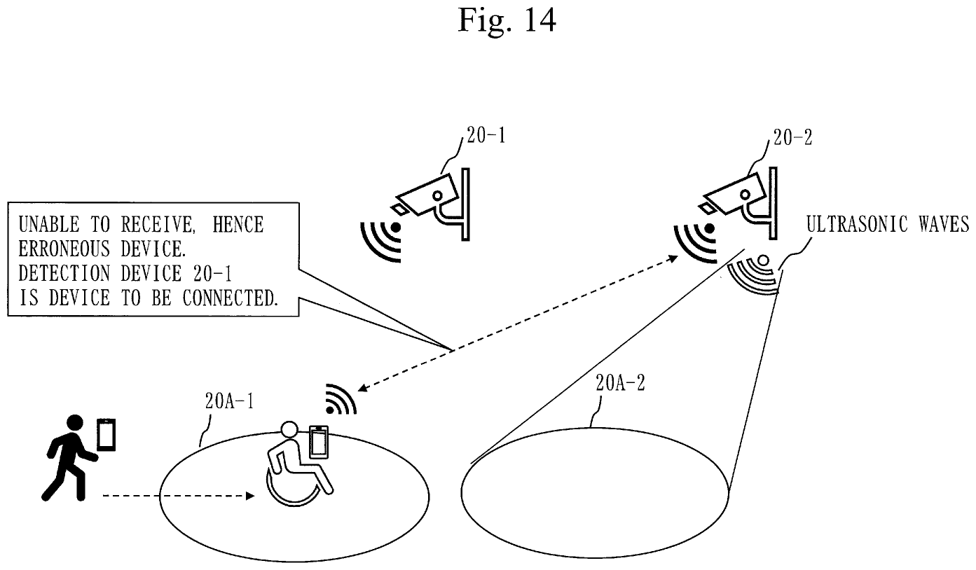

FIG. 14 illustrates a case where a transmission destination device 20D is determined erroneously.

In a mobile terminal 10-1, a terminal-side stationary state detection unit 11 starts judging a stationary state of the mobile terminal 10-1 with a motion sensor. A timer is started simultaneously with the start of stationary state judgment. After the transmission destination device 20D is determined, the transmission control unit 12 requests the determined transmission destination device 20D to transmit ultrasonic waves. If the ultrasonic wave reception device 162 is able to receive the ultrasonic waves within a predetermined period of time, the transmission control unit 12 determines that the determined transmission destination device 20D is a true transmission destination device 20D, and proceeds to a process of step S30. On the other hand, as illustrated in FIG. 14, if the ultrasonic wave reception device 162 is not able to receive the ultrasonic waves, the transmission control unit 12 determines the transmission destination device 20D erroneously. Hence, the transmission control unit 12 performs the same process on a detection device 20 that should be a next transmission destination device 20D. The transmission control unit 12 can transmit an ultrasonic wave transmission request to a plurality of detection devices 20. In this case, the mobile terminal 10 can discriminate a detection device 20 that should be a next transmission destination device, by shifting an ultrasonic wave transmission timing, repeating ON and OFF of ultrasonic wave transmission with a predetermined cycle, and so on.

As described above, the transmission control unit 12 requests the transmission destination device to transmit ultrasonic waves, and upon reception of the ultrasonic waves, transmits the identification information and the terminal-side time to the transmission destination device. When a reception control unit 21 receives from the mobile terminal 10 a transmission request requesting ultrasonic wave transmission, the reception control unit 21 causes the ultrasonic wave transmission device 262 to transmit ultrasonic waves.

According to Modification 2, the transmission destination device 20D can be determined more precisely than in a case where ultrasonic waves are not employed. Therefore, person position information and identification information can be associated with each other with a higher precision.

### <Modification 3>

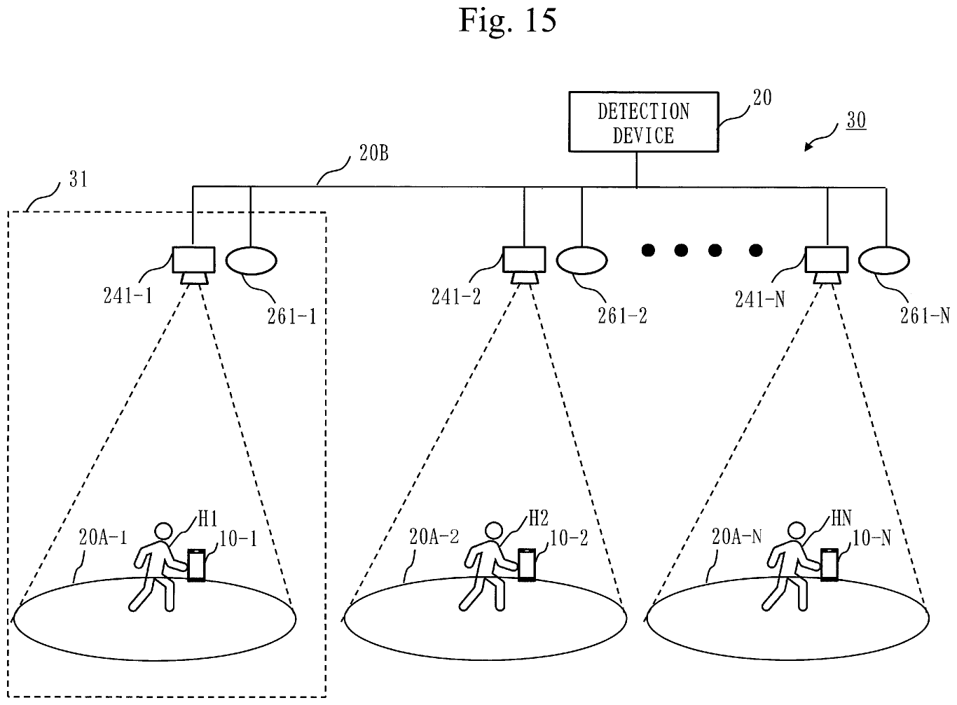

FIG. 15 illustrates Modification 3. In Embodiment 1, each detection device 20 is an independent device. In contrast to this, in Modification 3 of FIG. 15, a photographing device 241 and a communication device 261 are placed at a position of each detection device 20 of Embodiment 1. Functions the other detection devices 20 are integrated in one detection device 20. Functions of detection device 20-1 to detection device 20-N may be integrated in a plurality of detection devices 20.

### <Supplement to Hardware Configuration>

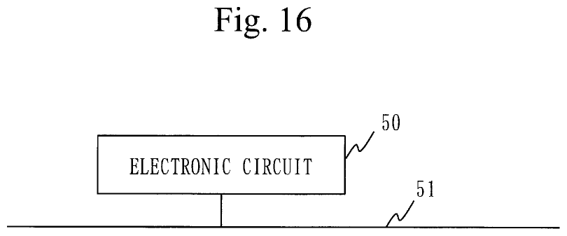

The function of the mobile terminal 10 of FIG. 2 and the function of the detection device 20 of FIG. 3 are both implemented by software. However, the function of the mobile terminal 10 and the function of the detection device 20 may both be implemented by hardware. FIG. 16 illustrates a configuration in which the function of the detection device 20 is implemented by hardware. The case where the function of the mobile terminal 10 is implemented by hardware is the same as the case of the detection device 20, and accordingly the description of the detection device 20 applies to the mobile terminal 10 as well. An electronic circuit 50 of FIG. 16 is a dedicated electronic circuit that implements the functions of the reception control unit 21, position detection unit 22, device-side stationary state detection unit 23, and associating unit 24, of the detection device 20. The electronic circuit 50 is connected to a signal line 51. The electronic circuit 50 is specifically a single circuit, a composite circuit, a programmed processor, a parallel-programmed processor, a logic IC, a GA, an ASIC, or an FPGA. Note that GA stands for Gate Array, ASIC stands for Application Specific Integrated Circuit, and FPGA stands for Field-Programmable Gate Array. The functions of the constituent elements of the detection device 20 may be implemented by one electronic circuit, or may be implemented by a plurality of electronic circuits by sharing. Some of the functions of the constituent elements of the detection device 20 may be implemented by an electronic circuit, and the remaining functions may be implemented by software.

A processor 210 and the electronic circuit 50 are called processing circuitry or circuitry. In the detection device 20, the functions of the reception control unit 21, position detection unit 22, device-side stationary state detection unit 23, and associating unit 24 may be implemented by circuitry.

Embodiment 1, Modification 1, Modification 2, and Modification 3 have been described above. Among Embodiment 1, Modification 1, Modification 2, and Modification 3, two or more may be practiced by combination. Alternatively, among Embodiment 1, Modification 1, Modification 2, and Modification 3, one may be practiced partly. Alternatively, among Embodiment 1, Modification 1, Modification 2, and Modification 3, two or more may be practiced by combination in part.

### REFERENCE SIGNS LIST

1: chair; TC: terminal-side time; TS: device-side time; 10: mobile terminal; 11: terminal-side stationary state detection unit; 12: transmission control unit; 13: movement detection unit; 20: detection device; 20A: detection area; 20B: network; 20D: transmission destination device; 21: reception control unit; 22: position detection unit; 23: device-side stationary state detection unit; 24: associating unit; 27: failure notice; 30: detection system; 31: basic unit; 50: electronic circuit; 51: signal line; 110: processor; 120: main storage device; 130: auxiliary storage device; 140: input IF; 150: output IF; 160: communication IF; 170: signal line; 141: motion sensor; 161: communication device; 162: ultrasonic wave reception device; 210: processor; 220: main storage device; 230: auxiliary storage device; 231: detection program; 240: input IF; 250: output IF; 260: communication IF; 270: signal line; 241: photographing device; 261: communication device; 262: ultrasonic wave transmission device.

1. A detection system comprising a mobile terminal carried by a person and a detection device which detects a position of the person,
wherein the mobile terminal comprises terminal-side circuitry
to detect a terminal-side time expressing a duration time of a stationary state of the mobile terminal with using a motion sensor, and
to transmit the terminal-side time and identification information which identifies the mobile terminal, and
wherein the detection device comprises device-side circuitry
to receive the terminal-side time and the identification information,
to detect a person position from an image by image analysis of the image photographed by a photographing device,
to detect a device-side time indicating a duration time of a stationary state of the person existing in the image by image analysis, and to compare the device-side time with the terminal-side time, and
to decide whether or not to associate the person position with the received identification information in accordance with a comparison result of the terminal-side time and the device-side time.

2. The detection system according to claim 1,
wherein the terminal-side time is a time length fixed as a regulation value,
wherein the device-side time is a time from stationary state start to reception of the terminal-side time, and
wherein when the duration time of the stationary state of the mobile terminal reaches the regulation value, the terminal-side circuitry transmits the identification information and the terminal-side time.

3. A mobile terminal carried by a person, comprising
terminal-side circuitry
to detect a terminal-side time expressing a duration time of a stationary state of the mobile terminal with using a motion sensor, and
to determine a transmission destination device to which the identification information and the terminal-side time should be transmitted, from among a plurality of detection devices which detect a person position by image analysis and which associate the person position with the identification information identifying the mobile terminal, on a basis of characteristics of electric waves transmitted by each of the plurality of detection devices, and to transmit identification information which identifies the mobile terminal, and the terminal-side time, to the determined transmission destination device.

4. The mobile terminal according to claim 3,
wherein the terminal-side circuitry requests the transmission destination device to transmit ultrasonic waves, and upon reception of the ultrasonic waves, transmits the identification information and the terminal-side time to the transmission destination device.

5. The mobile terminal according to claim 3,
wherein after transmitting the identification information and the terminal-side time, when the terminal-side circuitry receives from the transmission destination device a failure notice notifying failure of associating the person position with the identification information, the terminal-side circuitry determines another transmission destination device to which the identification information and the device-side time should be transmitted, from among the plurality of detection devices.

6. The mobile terminal according to claim 4,
wherein after transmitting the identification information and the terminal-side time, when the terminal-side circuitry receives from the transmission destination device a failure notice notifying failure of associating the person position with the identification information, the terminal-side circuitry determines another transmission destination device to which the identification information and the device-side time should be transmitted, from among the plurality of detection devices.

7. The mobile terminal according to claim 4,
wherein the terminal-side circuitry transmits the identification information and a delete instruction which instructs deletion of information indicating associated relation of the identification information and the person position with each other, when a movement continuation state of a predetermined period of time of the mobile terminal is detected with the motion sensor.

8. The mobile terminal according to claim 5,
wherein the terminal-side circuitry transmits the identification information and a delete instruction which instructs deletion of information indicating associated relation of the identification information and the person position with each other, when a movement continuation state of a predetermined period of time of the mobile terminal is detected with the motion sensor.

9. The mobile terminal according to claim 6,
wherein the terminal-side circuitry transmits the identification information and a delete instruction which instructs deletion of information indicating associated relation of the identification information and the person position with each other, when a movement continuation state of a predetermined period of time of the mobile terminal is detected with the motion sensor.

10. A detection device comprising
device-side circuitry
to receive identification information which identifies a mobile terminal carried by a person, and a terminal-side time expressing a duration time of a stationary state of the mobile terminal and detected by the mobile terminal with using a motion sensor, from the mobile terminal,
to detect a person position from an image by image analysis of the image photographed by a photographing device,
to detect a device-side time indicating a duration time of a stationary state of the person existing in the image by image analysis, and to compare the device-side time with the terminal-side time, and
to decide whether or not to associate the person position with the received identification information in accordance with a comparison result of the terminal-side time and the device-side time.

11. The detection device according to claim 10,
wherein when it is determined that the person position will not be associated with the received identification information, the device-side circuitry transmits a failure notice notifying a failure of associating the person position with the identification information.

12. The detection device according to claim 10, further comprising an ultrasonic wave transmission device,
wherein when the device-side circuitry receives from the mobile terminal a transmission request requesting ultrasonic wave transmission, the device-side circuitry causes the ultrasonic wave transmission device to transmit ultrasonic waves.

13. The detection device according to claim 11, further comprising an ultrasonic wave transmission device,
wherein when the device-side circuitry receives from the mobile terminal a transmission request requesting ultrasonic wave transmission, the device-side circuitry causes the ultrasonic wave transmission device to transmit ultrasonic waves.

14. The detection device according to claim 10,
wherein upon reception of the identification information and a delete instruction which instructs deletion of information indicating associated relation of the identification information and the person position with each other, the device-side circuitry deletes the associated relation of the identification information and the person position with each other.

15. The detection device according to claim 11,
wherein upon reception of the identification information and a delete instruction which instructs deletion of information indicating associated relation of the identification information and the person position with each other, the device-side circuitry deletes the associated relation of the identification information and the person position with each other.

16. The detection device according to claim 12,
wherein upon reception of the identification information and a delete instruction which instructs deletion of information indicating associated relation of the identification information and the person position with each other, the device-side circuitry deletes the associated relation of the identification information and the person position with each other.

17. The detection device according to claim 13,
wherein upon reception of the identification information and a delete instruction which instructs deletion of information indicating associated relation of the identification information and the person position with each other, the device-side circuitry deletes the associated relation of the identification information and the person position with each other.

18. A non-transitory computer readable medium storing a transmission program which causes a mobile terminal being a computer carried by a person, to execute
a terminal-side stationary state detection process of detecting a terminal-side time expressing a duration time of a stationary state of the mobile terminal with using a motion sensor, and
a transmission control process of transmitting the terminal-side time and identification information which identifies the mobile terminal,
wherein the transmission control process comprises determining a transmission destination device to which the identification information and the terminal-side time should be transmitted, from among a plurality of detection devices which detect a person position by image analysis and which associate the person position with the identification information identifying the mobile terminal, on a basis of characteristics of electric waves transmitted by each of the plurality of detection devices, and transmitting the identification information and the terminal-side time to the determined transmission destination device.

19. A non-transitory computer readable medium storing a detection program which causes a computer to execute
a reception control process of receiving identification information which identifies a mobile terminal carried by a person, and a terminal-side time expressing a duration time of a stationary state of the mobile terminal and detected by the mobile terminal with using a motion sensor, from the mobile terminal,
a position detection process of detecting a person position from an image by image analysis of the image photographed by a photographing device,
a device-side stationary state detection process of detecting a device-side time indicating a duration time of a stationary state of the person existing in the image by image analysis, and comparing the device-side time with the terminal-side time, and
an associating process of deciding whether or not to associate the person position with the received identification information in accordance with a comparison result of the terminal-side time and the device-side time.
